(19) United States
(12) Patent Application Publication
(10) Pub. No.: US 2007/0249971 A1
(43) Pub. Date: Oct. 25, 2007

(54) Portable physiotherapy apparatus for providing resistive exercise movement and method of using same

(76) Inventor: Kenneth B. Doran, Sarnia (CA)

Correspondence Address: RICHES, MCKENZIE & HERBERT, LLP, SUITE 1800, 2 BLOOR STREET EAST, TORONTO, ON, M4W 3J5, US

(21) Appl. No.: 11/717,005

(22) Filed: Mar. 13, 2007

(30) Foreign Application Priority Data
Apr. 25, 2006 (CA) 2,544,811

(51) Int. Cl. A61H 1/00

(52) U.S. Cl. 601/27

(57) ABSTRACT

The physiotherapy apparatus includes a frame and at least one or more resiliently deformable elastomeric bands which are adapted to be secured to the frame and secured under deformed tension to a user's leg or arm to provide tensioning force. The frame extends along an axis from a rearward end positioned proximal to the user, to a forwardmost distal end, remote therefrom. A support pad mounted to the frame towards the rearward end is used to support the user's arm or leg in a generally forward extending outstretched orientation. A number of coupling elements are mounted to the frame at spaced locations selected having regard to the resiliency and configuration of the deformable members secured thereto and engaged by the user, the resiliency of the deformable member provides a desired tensioning force for resistive exercise movement. A forward distalmost coupling element is positioned towards the forward end of the frame and in use may be used to secure the deformable band to the user's arm or leg. Two pairs of lateral support posts are further symmetrically disposed along each side of the frame axis. A first pair of lateral support posts is provided at approximately midway between rearward and forwardmost ends of the frame, to locate laterally substantially adjacent to each side of the user's foot or hand, when for example, the user's arm or leg is positioned in an exercising position on the support pad. The second other pair of coupling posts are positioned on each side of the frame axis adjacent the rearward end, to facilitating gripping by the user's hand to steady the frame in exercise movement.

### SCOPE OF THE INVENTION

The present invention relates to a physiotherapy apparatus for use in providing resistive exercising movement, and more particularly, a portable physiotherapy apparatus which includes one or more resiliently deformable members or bands which are engageable by a user's limb to provide a tensioning extension or flexion force thereon.

### BACKGROUND OF THE INVENTION

In the conventional physiotherapy treatment of a user's limb joints, such as the ankle, knee and/or wrist, a patient is typically positioned in a reclined position on a physiotherapy table. Traction is thereafter applied to the limb through a mechanical or other weighted-traction/pulley arrangement, to provide a tensioning extension or flexion force thereon. By way of example, U.S. Pat. No. 5,616,110 to Nascimento, issued 01 Apr. 1997, describes a prior art physiotherapy table which is adapted for dedicated use by a physiotherapist to provide muscular elongation and/or flexion movement to a user's limb as part of a physiotherapy treatment. Dedicated physiotherapy tables and other traction/pulley arrangements are typically cumbersome and expensive, and for practical purposes, necessitate that the physiotherapy occur in a clinical environment. This effectively prevents the patient from initiating meaningful independent physiotherapy exercises at home, or otherwise outside scheduled appointment hours with a clinician. This in turn limits both the time and frequency of any therapeutic treatments, delaying patient recovery.

### SUMMARY OF THE INVENTION

The present invention seeks to provide a portable physiotherapy apparatus for use in effecting muscular elongation extension, flexion or other resistive exercising movement to a user's foot, ankle, leg and/or arm or wrist, as part of a physiotherapy and/or exercise regime. More preferably, the apparatus is formed with a sufficiently reduced size and weight as to enable the apparatus to be transported, stored and independently used in a home environment by the individual patient/user, without clinician support.

Another object of the invention is to provide a physiotherapy apparatus which may be easily and inexpensively manufactured, and which incorporates one or more resiliently deformable members which may be used to effect a number of different exercises, as part of a complete physiotherapy regime.

A further object of the invention is to provide a lightweight physiotherapy apparatus which has an overall length and width which is selected to enable the apparatus to be positioned and used on either a floor for in home use, or on top of a conventional physiotherapy, massage, or examination table, as part of a clinical physiotherapy regime.

Another object of the invention is to provide a physiotherapy apparatus which includes an axially elongated frame having a number of axially displaced coupling members used to secure thereto at least one resiliently deformable elastomeric member, whereby the selective engagement of the elastomeric members with different combinations of coupling members may be used to provide a variety of different exercising extension and/or flexion movements and/or tensioning forces to a user's arm, foot and/or ankle.

The physiotherapy apparatus is provided with a frame and one or more resiliently deformable members which in use, are secured to the frame and adapted to be gripped by, engaged, or otherwise secured under deformed tension to a user's limb when so coupled, the deformable members provide a tensioning force on the user's limb, against which the user may effect resistive exercising movement as part of an exercise or physiotherapy regime. By way of non-limiting examples, the resiliently deformable members may comprise compressible or extensible springs, deformable webs or straps, or in a most simplified and preferred construction, elastomeric or rubber bands. Preferably, the frame extends along a generally forward axis from a rearward end adapted for positioning proximal to the user to a forwardmost distal end, remote therefrom. A support pad is mounted to the frame. In a most preferred construction, the support is spaced towards the rearward end of the frame for use in supporting the user's arm or leg thereon in an exercising position, wherein the arm or leg is positioned in a generally forward extending outstretched orientation aligned with the frame axis. Optionally, one or more straps may be provided for use in securing the user's arm or leg on the support pad in the desired orientation for exercising movement and more preferably, substantially aligned over the forward extending axis of the support frame, so that the user's hand or foot is suspended above a remainder of the frame in a cantilevered arrangement. Preferably, the support pad is positioned on the frame so as to allow a slight deflection of the user's knee, when his or her arm is positioned thereon. The applicant has appreciated that in leg exercises a slight knee deflection advantageously allows a greater range of exercising motion and more muscle groups to be utilized.

One or more coupling elements are secured to or integrally formed with the frame at spaced locations for use in engaging and/or securing portions of the resiliently deformable member thereto. By way of non-limiting example, the coupling elements may consist of hooks, grommets, screws, loops, pins, posts, or other types of fasteners which are constructed to permanently or temporarily connect the deformable members to the frame. The coupling elements are provided at locations selected having regard to the resiliency, configuration and overall dimensions of the deformable members such that when a selected deformable member is both secured thereto and engaged by the user's foot, hand, or the like, the resiliency of the deformable member provides a desired tensioning force for resistive exercise movement. In a most simplified construction, where the frame is used in conjunction with one or more elastically deformable rubber bands or other elastomeric members for use in providing resistive exercising movement, the coupling elements consists of vertically extending dowels or posts which project upwardly from a remainder of the frame. With such a configuration, the elastomeric or rubber bands which are most preferably provided as a continuous loop having closed loop ends to provide simplified coupling to both the user's foot or wrist to provide a flexion or tensioning force thereon, as well as vertical posts.

Most preferably, a forward distalmost coupling post is positioned towards the forward end of the frame, generally aligned over the frame axis. The distalmost post is configured to be selectively engaged by and retain a portion of a band in use of the apparatus to effect toe pulling exercises.

The frame is provided with an overall axial length selected such that when the user's arm or calf is positioned on the support pad with his arm or leg aligned with the frame axis and band or toe pointing upwardly in the exercising position, the distalmost post is spaced a selected distance from the end of the foot so that when the band is stretched therebetween, the band provides a desired degree of axial forward tensioning force or elongation on the user's hand or foot. The user may thus pivot his hand or foot rearwardly against the resilient forward pulling force of the band to effect rearward wrist or toe pulling exercises.

Although not essential, most preferably, the frame also includes at least one, and more preferably at least two pairs of lateral support posts symmetrically disposed along each side of the frame axis. A first pair of lateral support posts is provided at approximately midway between rearward and forwardmost ends of the frame, and most preferably so as to locate laterally substantially adjacent to each side of the user's foot or hand when the user's arm or leg is positioned on the support pad in the exercising position. The lateral posts are spaced from each other and the frame axis by a distance selected so as to be selectively engageable by secure portions of the band to provide a desired lateral tensioning force by the user's foot and hand. The user may thus pivot his foot or hand sideways against the resilient lateral pulling force of the band to effect outward or inward tensioning exercises.

The second other pair of coupling posts are preferably positioned on each side of the frame axis adjacent the rearward end. In addition to facilitating gripping by the user's hand to steady the frame in exercise movement, the rearwardmost post may be used in conjunction with a deformable band to effect forward wrist or toe extension exercises. In particular, the band may be looped over both posts and stretched axially forward across the palm of the hand or bottom of the foot to provide an axially rearward tensioning force.

The applicant has appreciated that providing, in combination, a number of axially displaced coupling members enables the physiotherapy apparatus to be used to effect a number of different controlled flexion and/or traction exercises. For example, therapeutic resistive exercise for the rehabilitation of ankle injuries, wrist injuries, forward and rearward toe pulling exercises and laterally outward and inward toe pull exercises may all be effected by reconfiguring the band/coupling member attachment.

Accordingly, in one aspect the present invention resides in a physiotherapy apparatus for providing resistive exercising movement to a user's foot, said apparatus comprising,

at least one resiliently deformable elastomeric member, each said at least one elastomeric member having a first portion engageable by said user's foot,

a frame comprising a base,
a support member secured to said frame base for supporting the user's leg thereon in a generally forward extending outstretched orientation,

a plurality of coupling members for selectively coupling a second portion of said at least one elastomeric member spaced from said first portion to said frame at one or more locations,

wherein the at least one elastomeric member having a length selected such that when said first end portion is engaged by said user's foot and said second portion of said elastomeric member is coupled to at least one coupling member, said elastomeric member provides a tensioning force on said user's foot.

In another aspect, the present invention resides in a physiotherapy apparatus for providing a resilient elongation or flexion force to a user's foot, the apparatus comprising,

an elongated resiliently deformable elastomeric member having a first portion and a second portion spaced from said first portion, said first portion being selectively engageable by said user's foot,

a frame comprising a base extending along an axis from a rearward end to a forward end,

a support member mounted to said base for supporting the user's leg thereon in a generally forwardly extending outstretched orientation substantially aligned with said axis,

a distalmost coupling member spaced forwardly from said support surface, said distalmost coupling member configured to selectively engage a second portion to secure said elastomeric member relative to said frame, the relative spacing of distalmost coupling member from said support member and the length of the elastomeric member selected whereby when said user's leg is supported on said support member and first end portion is engaged by said user's foot and said second portion is coupled to the distalmost coupling member, said elastomeric member provides a therapeutic axial tensioning force on said user's foot.

In a further aspect, the present invention resides in a portable physiotherapy apparatus for providing resistive exercising movement to a user's limbs, said apparatus comprising,

a frame extending along a generally central axis from a rearward most end to a forward end and having an overall length and width selected for placement on a planar top surface of a conventional physiotherapy table,
a support member coupled to said frame for supporting a portion of the user's limb thereon in an exercising position extending generally in a forward outstretched orientation substantially aligned with the axis,
a resiliently deformable elastomeric member,
a distalmost coupling member engageable by a distal portion of said elastomeric member and spaced towards said forward end,
a pair of lateral coupling members each of said lateral coupling members being on laterally positioned opposing sides of said axis

the elastomeric member having a length selected such that when said user's limb is in the exercising position and said elastomeric member is engaged by both said user's limbs at least one of said distalmost and lateral coupling members, said elastomeric member exerts a desired tensioning force on said user's limb.

### BRIEF DESCRIPTION OF THE DRAWINGS

Reference may now be had to the following detailed description taken together with the accompanying drawings in which:

FIG. 1 illustrates a perspective top view of a portable physiotherapy apparatus in accordance with a preferred embodiment of the invention, with a resiliently deformable elastic band secured to distalmost coupling post for use in effecting rearward toe exercises;

FIG. 2 shows a plan view of the frame used in the physiotherapy apparatus of FIG. 1;

FIG. 3 shows a schematic rearward end view of the frame shown in FIG. 2;

FIG. 4 shows a schematic side view of the frame shown in FIG. 2;

FIG. 5 illustrates a schematic top view of the apparatus of FIG. 1 in use to effect rearward toe pulling exercises with a user's leg secured in the exercising position;

FIG. 6 illustrates a schematic top view of the apparatus in FIG. 1 in use to effect lateral outward pulling exercises on the user's foot;

FIG. 7 illustrates a partial top view of the apparatus of FIG. 1, illustrating the connection of the resilient band to the frame in use to effect lateral inward pulling exercise on the user's leg;

FIG. 8 illustrates a schematic top view of the apparatus of FIG. 6 illustrating the manual application of a further tensioning force on the resiliently deformable band;

FIG. 9 illustrates a schematic top view of the apparatus in FIG. 1 illustrating the connection of the resilient band to the frame in use to effect forward toe extension exercises.

### DETAILED DESCRIPTION OF THE PREFERRED EMBODIMENT

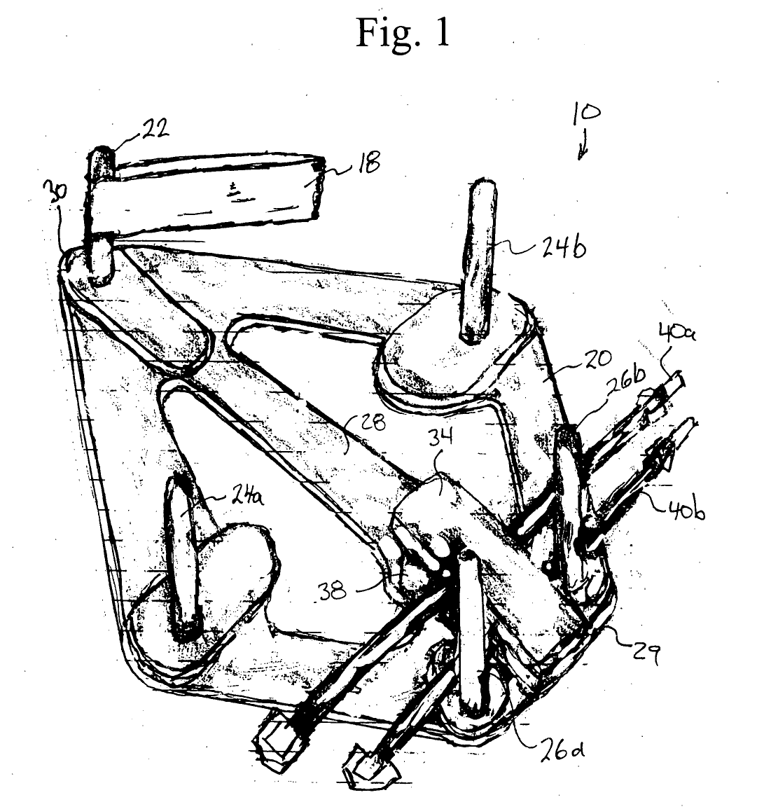

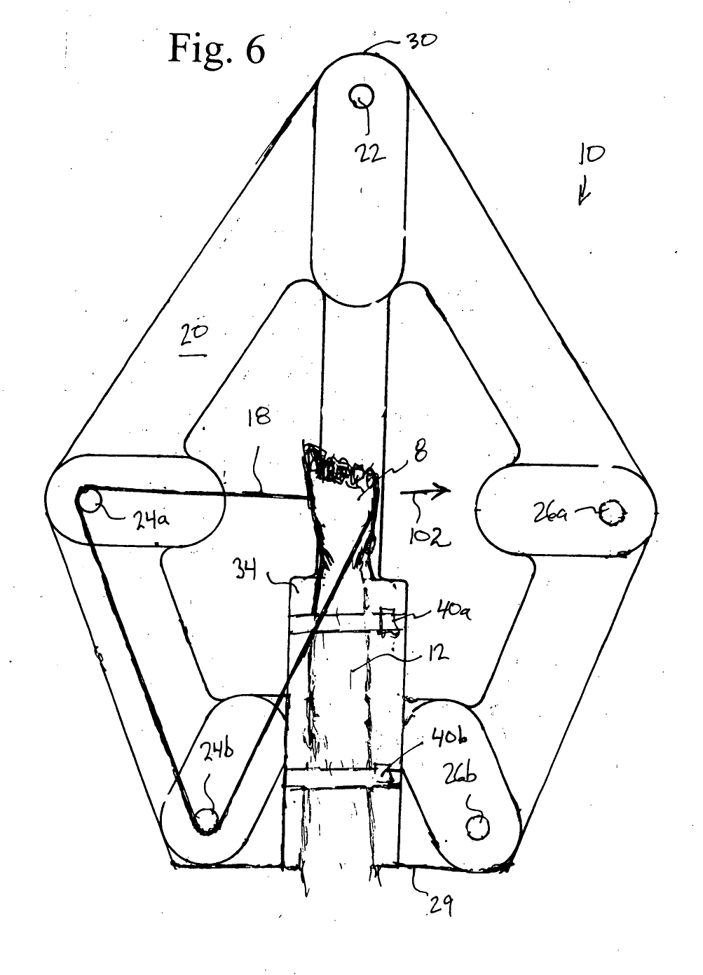

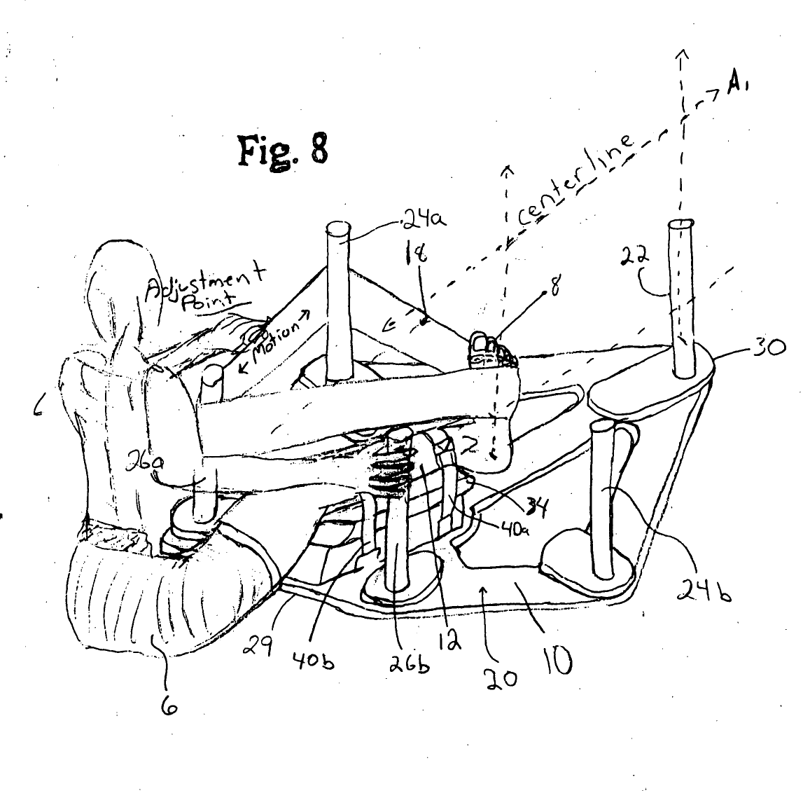

Reference may first be had to FIG. 1 which shows a portable physiotherapy apparatus 10, which as will be described, is adapted for either home or clinical use in providing elongation and/or flexion resistive exercising movement to the ankle and foot 8 of a user 6 (FIG. 8). The physiotherapy apparatus 10 advantageously may be used to provide resilient elongation and resistive exercise forces to the user's foot 8 to thereby assist in enhancing blood flow circulation and muscle strengthening to the entire leg 12 (FIG. 5) as part of a physiotherapy regime. The apparatus 10 includes a resiliently deformable elastomeric rubber band 18 which, as will be described, is adapted to be secured to the user's foot 8 and selectively coupled under tension to various different points on a frame 20 by the engagement with one or more coupling posts 22,24a,24b,26a,26b.

The rubber band 18 is preferably 4 to 15 cm wide and has lopped ends. The band 18 has a resiliency selected to enable it to be stretched or elastically deformed from an undeformed length between about 10 and 20 cm to a stretched length of at least about 30 cm, and more preferably at least about 40 cm, without risk of breakage or loss of elasticity. As will be described, the resiliency of the rubber band 18 is used to provide the traction/flexion forces on the end of the user's foot 8, and provide the desired degree of resistive exercising movement. Preferably, the elastic band 18 may be purchased as a preformed continuous loop of material or alternately, as part of a roll of elastomeric material which is then cut to the desired lengths. Although an elastic band 18 which is preformed as a continuous loop is preferred for ease of securement to the connecting post 22,24a,24b,26a,26b, it is to be appreciated that in the alternate construction it is possible to cut a desired length of material which is thereafter tied directly to the posts 22,24a,24b,26a,26b or incorporated with other connectors. Although more time consuming, the use of a length of elastomeric material cut to a desired length advantageously allows the user to more precisely tailor the degree of resistance to be provided by the band 18 to an optimum comfort level.

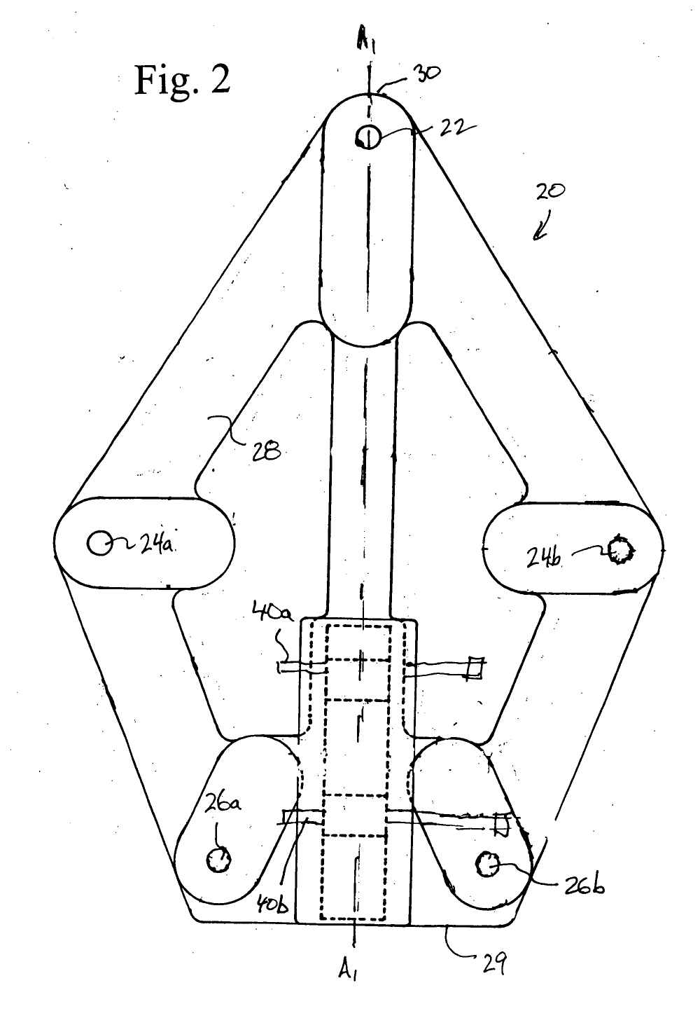

The frame 20 is preferably made of a lightweight material such as fibreglass or molded plastic, although in alternate constructions, wood and/or metals may also be used. FIGS. 2 to 4 show best the frame 20 as having a flat base 28 to facilitate its stable placement on a floor or table surface. The frame 20 axially elongated along its center line or a central frame axis A₁-A₁ (FIG. 2), and extending from a rearward end 29 which in use, is positioned closest to the user 12 to a forwardmost end 30 remote therefrom. The frame 20 preferably has an overall longitudinal length in the axial direction selected at between about 1 and 1.5 metres. The lateral width of the frame 20 is selected to provide the apparatus 10 with adequate stability in lateral twisting exercises and minimize the likelihood of tipping or twisting in use. Preferably, the frame 20 has a lateral width selected at between about 0.5 and 1 metres, and most preferably about 0.75 metres. Although not essential, the frame 20 is most preferably symmetrically formed about the axis A₁-A₁ providing it with a mirror profile thereabout. The overall smaller dimensions of the frame 20 advantageously enable the apparatus 10 to be easily moved, transported, and/or stored. In addition, the lateral width and length of the frame 20 permit the apparatus 10 to be positioned and used on the surface of a conventional physiotherapy table for clinical use by a physiotherapist, without requiring a specialized or dedicated physiotherapy table. It is to be appreciated, however, that larger or small frame constructions may also be used.

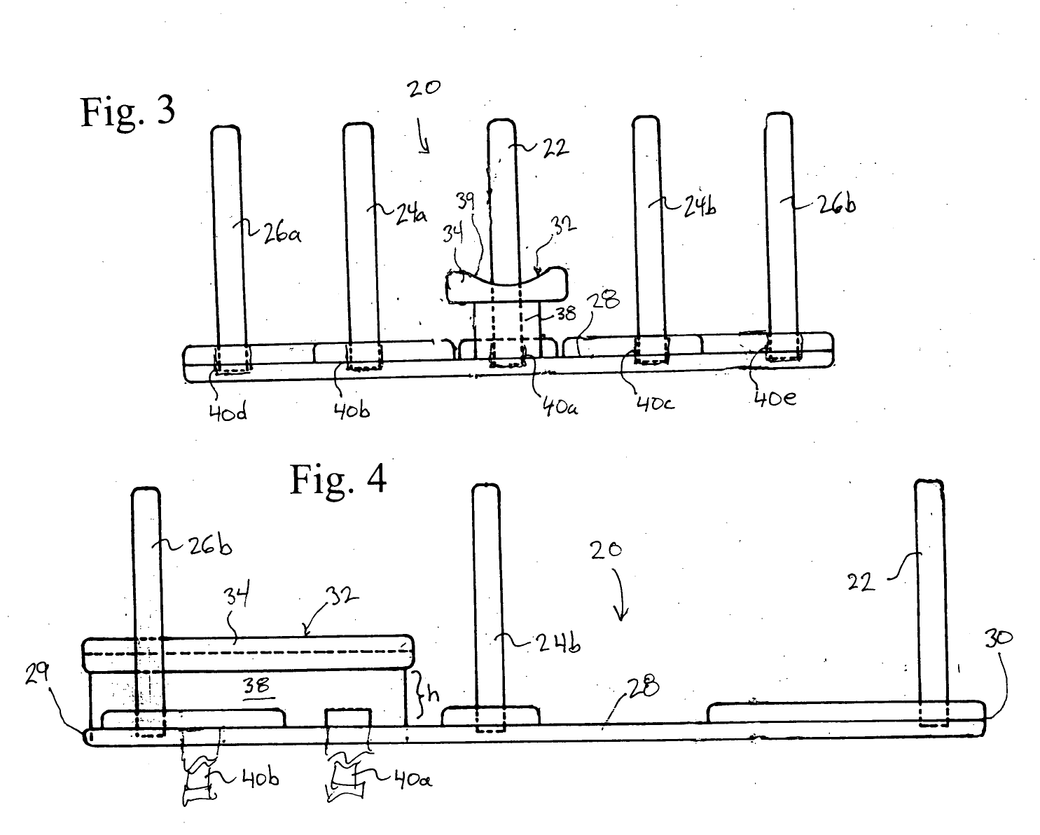

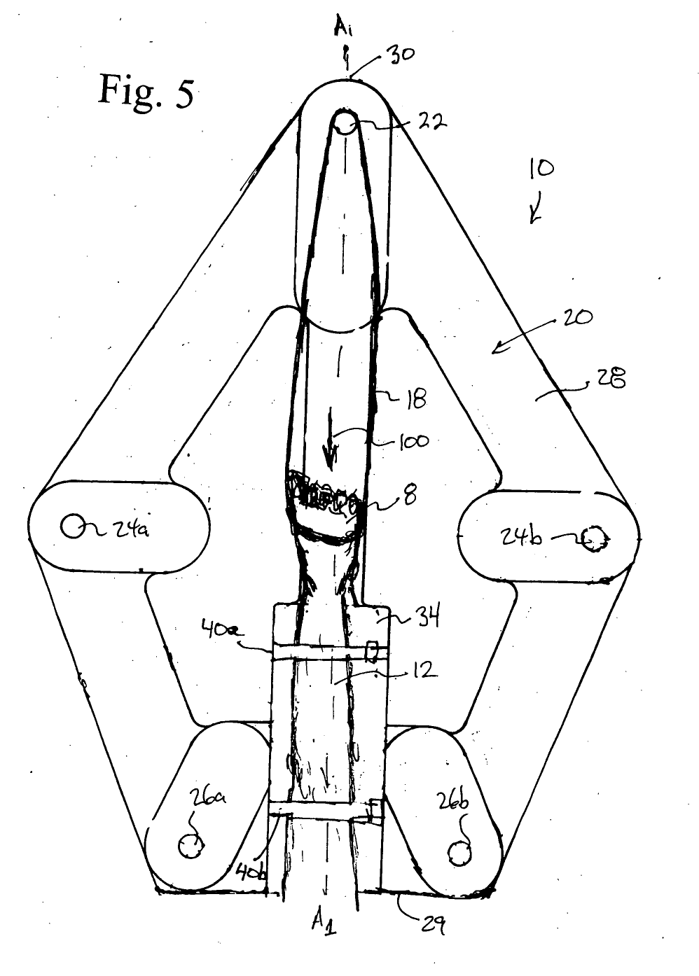

FIGS. 3 and 4 show best the frame 20 as including an arm/leg support assembly 32 which projects upwardly from the base 28, in addition to the connecting posts 22,24a,24b,26a,26b. The arm/leg support assembly 32 is positioned immediately adjacent to the rearwardmost end 29 of the frame 20, and extends generally along the axis A₁-A₁, preferably ¼ to 1/2 the overall axial length of frame 20. The support assembly 32 includes a padded cushion 34 which is mounted on top of a raised support 38. The support 38 extends a height (FIG. 4) of about 5 to 10 cm above the base 28. The support 38 positions the cushion 34 at a height selected to support the calf of the user's leg 12 so that the user's ankle and foot 8 are supported in a cantilevered arrangement raised a distance of between 1 and 10 cm above a remainder of the frame 20. It is to be appreciated that when so raised, the frame 20 does not otherwise interfere with the extension or retraction of the user's foot 8. Although not essential, most preferably the padded cushion 34 is formed having an upper surface 39 (FIG. 3) which is concavely formed in the lateral direction, to assist in cradling the user's calf 12 in a desired orientation directly aligned with the frame axis A₁-A₁. Most preferably, the cushion 34 is raised a height above the base 28 and adjacent frame 20 so that when the user 6 is seated for exercising movement and the user's calf is positioned on the cushion 34, the user's leg 12 will orient with a slight deflection of between about 5 and 20° at the knee. The applicant has appreciated that in deflecting the knee during leg exercising movement, more muscle groups and a greater proportion of leg muscle mass may be exercised, than compared to exercise movement where the leg is kept flat. This in turn results in relatively greater muscle tissue compressions and extensions, and greater circulation.

A series of straps 40a,40b are provided to firmly retain the user's leg 12 in the exercising position, wherein the user's calf rests on the padded cushion 34, and the leg 12 to be exercised is outstretched substantially aligned with and extended forwardly along the frame axis A₁-A₁, with the foot 8 pointed upwardly.

The configuration of the connecting posts 22,24a,24b,26a,26b on the base 30 advantageously permit the physiotherapy apparatus 10 to be used in extension and/or reflection exercises as part of a physiotherapy regime for a variety of different exercise movements. Each of the connecting posts 22,24a,24b,26a,26b have a construction and height selected so as to engage the rubber band 18 along its entire width in use of the apparatus 10, while minimizing the likelihood that the band 18 may slip therefrom during physiotherapy exercises. In a simplified construction, the connecting posts 22,24a,24b,26a,26b are provided as 1 to 3 cm diameter cylindrical dowels which extend perpendicularly upward from the base 28, a distance of about between 5 and 30 cm. Although not essential, for more compact storage and/or ease of transport, the connecting posts 22,24a,24b,26a,26b may be removably secured to the base 28 in a friction fit, within a respective complementary sized socket 40a,40b,40c,40d,40e (FIG. 3) formed therein.

FIG. 2 shows a first distalmost connecting post 22 as being secured to the base 28, adjacent to the forwardmost end 22 of the frame. Most preferably, the distalmost connecting post 22 is positioned directly over the axis A₁-A₁. The final spacing of the post 22 from the support pad 34 is selected having regard to length and resiliency of the band 18. In particular, the relative spacing is chosen when one end of the rubber band 18 is looped over both the post 22 and the user's leg is in the exercising position, the engagement of the user's foot 8 with the other remote end of the rubber band 18 provides a desired degree of traction or tensioning force on the user's foot 8 in the forward axially direction.

The connecting posts 24a,24b are shown in FIG. 2 as being positioned laterally on a respective lateral side of the axis A₁-A₁, approximately midway along the axial length of the frame 20. Most preferably, the lateral connecting posts 24a,24b are located so as to generally align with the user's foot 8 when his or her leg 12 is secured in an exercising position on top of the cushion 34, as for example is shown in FIG. 5.

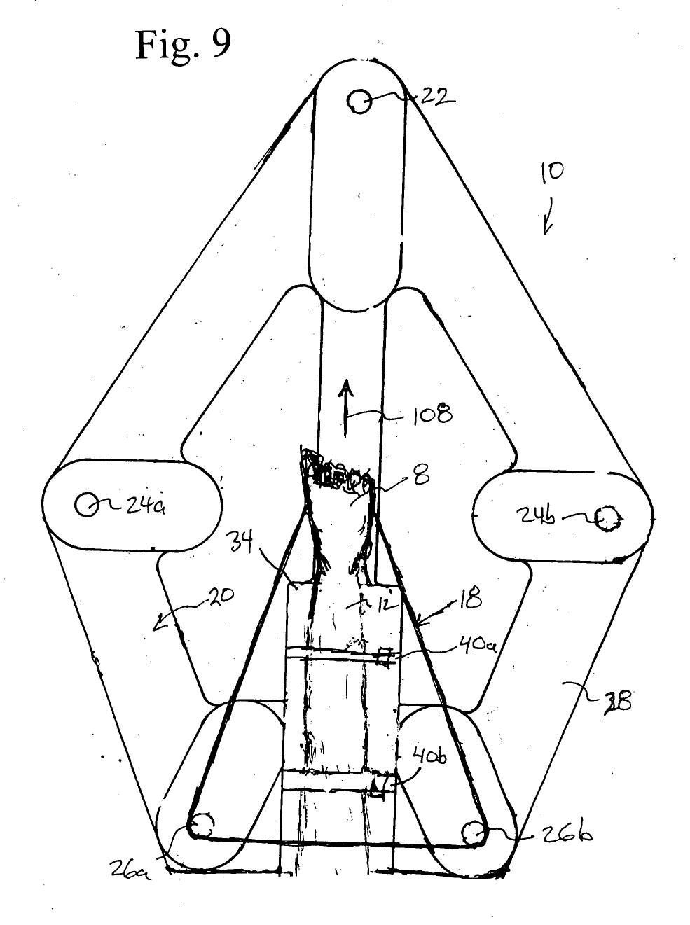

The remaining pair of posts 26a,26b are provided adjacent the rearward end 29 of the frame 20, at laterally spaced locations along each side of the support assembly 32. The posts 26a,26b are spaced from each other so as not to interfere with the positioning of the user's leg 12 on the cushion 34. As shown best in FIG. 9 the posts 26a,26b are separated from each other, so that when the band 18 is looped over both the posts 26a,26b and stretched forwardly so as to be moved against the underside of a user's foot 8, the band 18 provides a resilient rearward tensioning resistance force, permitting flexion exercises of the user's foot 8, when effecting toe pointing exercises. In addition to functioning as attachment members for the rubber band 18, the posts 26a,26b also act as handles whereby the user may grip the posts 26a,26b to minimize any undesired sliding of the frame 20 during exercising movement.

The posts 24a,24b and 26a,26b are most preferably further separated from each other by a respective distance selected so that when the user's leg 12 is secured in the exercising position and the band 18 is looped over the foot 8 and either the posts 24a,26a or the posts 24b,26b on either lateral side of the frame 20, and the band 18 provides a desired degree of lateral resistive forces to the user's foot 8 in effecting either lateral outward pull or inward pull exercising movement.

The applicant has appreciated that the positioning of the connecting posts 22,24a,24b,26a,26b relative to the leg supporting cushion 34 advantageously ensures a consistent securement point for the user's leg 12. This in turn permits the apparatus 10 to be used to effect a controlled and measurable set of the foremost commonly used physiotherapeutic exercises for ankle injuries, including forward toe pull exercises, toe pointing exercises, lateral inward rotation exercises and lateral outward rotation exercises. Furthermore, as will be described, the positioning of the connecting posts 22,24a,24b,26a,26b in the configuration shown in FIG. 2 allows a user to perform a variety of differing ankle exercise movements from a single seated position on the floor or table, without having to change positions or move heavy furniture or the like. In addition, the band 18/connecting posts 22,24a,24b,26a,26b spacing allows the manual application of additional tensioning force on the band 18 to center the tension force on the user's foot, as for example is shown in FIG. 8, by pinching the band at an adjustment point between either posts 24a,26a or 24b26b, depending on the leg exercise performed. The manual application of tensioning force on the band 18 further allows the user 6 to adjust or equalize the tensioning force on the feet 8 between push and pull exercises.

In initial use, the apparatus 10 is positioned with the base 38 oriented flat on the floor, or on the top surface of a flat physiotherapy table, and with the rearward end 29 of the frame 20 oriented closest to the user 6. The user 6 then assumes a seated position with the leg 12 to be exercised outstretched forwardly and aligned over the apparatus axis A₁-A₁. The calf is positioned resting against the cushion 34, so that the user's foot 8 is spaced forwarding from the support assembly 32 suspended above the underlying frame 30. The raised positioning of the cushion 34 above the base 30, thus, allows for substantially free movement of the foot 8 forward, rearward and lateral exercising movement. With the leg 12 so positioned, the straps 40a,40b are used to secure it against the cushion 36 in the exercising position so as to maintain alignment with the frame axis A₁-A₁. The band 18 may thereafter be looped over the foot 8 and selected one or more of the connecting posts 22,24a,24b,26a,26b to provide the desired resistive traction or flexion forces to the user's foot and ankle.

To effect rearward toe pull exercises, the band 18 is looped over the distalmost connecting post 22 and the top of user's foot 8 so as to be stretched in the direction of axis A₁-A₁ as shown in FIG. 5. In such a configuration, the band 18 provides a forward traction force on the user's ankle and foot allowing the user 6 to effect toe pull exercises in the direction of arrow 100 by extending or retracting his foot 8 rearwardly in the axially direction against the resilient pulling force of the rubber band 18. If desired, during exercise movement, the user 6 may furthermore grip the connecting posts 26a,26b with his hands to assist in maintaining balance and the apparatus 10 in the desired position, to better isolate the movement.

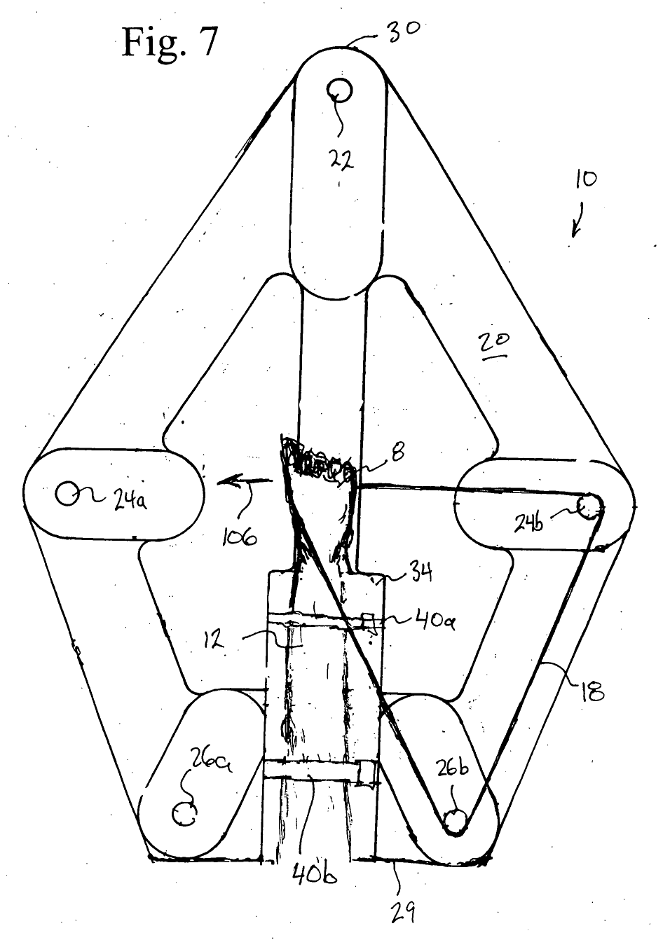

FIGS. 6 and 7 illustrate best the use of the apparatus 10 in effecting respectively outward pull exercises inward pull exercises. To achieve outward pull exercises, the band 18 is looped over each of the connecting posts 24a,26b as well as the user's foot 8 in the manner shown in FIG. 6. The user 6 then twists his ankle laterally relative to the axis A₁-A₁ and towards the connecting post 24b so as to move against the tension of the band 18 in the direction of arrow 102. If desired, as shown in FIG. 8, the user 6 may further increase the resistive force and tension on the band 18 by manually pushing or pulling on the band 18 between the posts 24a,26a to increase the extent of its deformation. As indicated, additional manual tensioning of the band 18 allows the user 6 to adjust the tensioning force on the foot 8, as by way of non-limiting example, to equalize or differentiate the tension between lateral outward and inward pull leg exercises, and the like.

Inward pull exercises of the user's foot 8 are effected in the opposite manner to the outward pull exercises shown in FIG. 6. As shown in FIG. 7, to achieve inward pull outward exercises, the rubber band 18 is looped over each the lateral connecting post 24b and the rear connecting post 26b, and about the user's foot 8 as shown in FIG. 7. In effecting inward pull exercising, the user rotates his foot 8 laterally relative to the axis A₁-A₁ towards the opposite connecting post 24a in the direction of arrow 106 and against the tension of the band 18. Increase in tension supplied by the band 18 may be effected in a similar manner to that described with reference to FIG. 8.

To effect forward toe pointing exercise, the rubber band 18 is looped over both the connecting posts 26a,26b and stretched forwardly across the bottom of the user's foot 8, as shown in FIG. 9. When so positioned, the user 6 may extend his or her foot 8 axially forward in the direction of arrow 108, and against the resistive forces of the band 18 to effect reflection exercises.

Although the detailed description of the invention describes the exercise apparatus 10 as used in the therapeutic exercise of a user's leg 12 and foot 8, the invention is not so limited. The apparatus 10 may also be used to exercise the user's arm, wrist, knees or such other limbs or joints. It is to be appreciated that in effecting wrist exercises, the user 6 would rest his forearm on the padded cushion 34 in an orientation generally aligned with the axis A₁-A₁, such that the user's hand and wrist extends midway between the lateral connecting posts 24a,24b. Thereafter, when so positioned, the rubber band 18 may be looped over one or more selected connecting posts 22,24a,24b,26a,26b in a similar manner as described with references to FIGS. 5, 6, 7 and 9 and the hand and/or wrist rotated or extended against the tensioning or flexion force of the band 18. Alternately, a handle (not shown) or other grippable element may be provided for attachment to the band 18 for gripping by the user's hand and/or engagement by the user's foot 8.

Although the preferred embodiments of the invention describe a single rubber band 18 as adapted to selectively be secured to one or more combinations of connecting posts 22,24a,24b,26a,26b, the invention is not so limited. It is to be appreciated that the apparatus 10 could equally be provided with a number of different rubber bands or other elastomeric members each having different lengths, widths, or configurations and being deformable to different degrees. In one possible such construction, rubber bands having a shorter overall undeformed length may be provided to effect outward or inward lateral exercising of the user's foot 8, and which are adapted to be coupled solely to the lateral posts 24a,24b of the frame 20, without connection to posts 26a,26b.

Although the preferred embodiment describes and illustrates the apparatus frame 20 as including cylindrical connecting posts 22,24a,24b,26a,26b as used to engage and retain portions of the rubber band 18, the invention is not so limited. It is to be appreciated that numerous different types of connecting members or mechanisms used to secure portions of the band 18 to the frame 20 may be used, and now will become apparent. Suitable connecting mechanisms would include, without limitation, clips, threaded fasteners, loops, friction clamps, hooks or the like.

Although the positioning of the distal most connecting post 22 in alignment with the axis A₁-A₁ advantageously allows the connecting post 22 to be used in traction exercise movement to either of the user's right or left leg, the invention is not so limited. It is to be appreciated that in an alternate construction, one or more connecting posts could be provided adjacent to the forwardmost end 22 of the frame 20, and spaced laterally from the axis A₁-A₁, for individual use when exercising the user's left and right legs, respectively.

Although the detailed description describes and illustrates various preferred embodiments, the invention is not so limited. Many modifications and variations will now occur to persons skilled in the art. For a definition of the invention, reference may be had to the appended claims.

I claim:

1. A physiotherapy apparatus for providing resistive exercising movement to a user's foot, said apparatus comprising,
at least one resiliently deformable elastomeric member, each said at least one elastomeric member having a first portion engageable by said user's foot,
a frame comprising a base,
a support member secured to said frame base for supporting the user's leg thereon in a generally forward extending outstretched orientation,
a plurality of coupling members for selectively coupling a second portion of said at least one elastomeric member spaced from said first portion to said frame at one or more locations,
wherein the at least one elastomeric member having a length selected such that when said first end portion is engaged by said user's foot and said second portion of said elastomeric member is coupled to at least one coupling member, said elastomeric member provides a tensioning force on said user's foot.

2. The apparatus as claimed in claim 1 wherein a first one of said plurality of coupling members comprises a distalmost coupling member spaced forwardly from said support surface, whereby when said second portion of said elastomeric member is coupled to said distalmost coupling member and said first portion is engaged by said user's foot, said elastomeric member provides a tensioning force on said user's foot in a forward direction generally aligned with the orientation of said user's leg.

3. The apparatus as claimed in claim 2 wherein said plurality of coupling members further include a pair of lateral coupling members, each of said lateral coupling members being positioned to selectively couple said second portion of said at least one elastomeric member to said frame at positions spaced on opposing lateral sides of said user's foot,
wherein when said second portion of said elastomeric member is coupled to a selected lateral coupling member and said first portion is engaged by said user's foot, said elastomeric member provides a tensioning force on said user's foot in a lateral direction generally transverse to the orientation of said user's leg.

4. The apparatus as claimed in claim 1 wherein said plurality of coupling members further include a pair of lateral coupling members, each of said lateral coupling members being positioned to selectively couple said second portion of said at least one elastomeric member to said frame at positions spaced on opposing lateral sides of said user's leg,
wherein when said second portion of said elastomeric member is coupled to a selected lateral coupling member and said first portion is engaged by said user's foot, said elastomeric member provides a tensioning force on said user's foot in a lateral direction generally transverse to the orientation of said user's leg.

5. The apparatus as claimed in claim 3 wherein said first coupling member comprises a generally vertically extending cylindrical peg positioned on said base at a location selected to be spaced forwardly a distance from said user's foot.

6. The apparatus as claimed in claim 3 wherein each of said coupling members comprises a generally vertically extending cylindrical peg detachably coupled to said frame.

7. The apparatus as claimed in claim 3 wherein said elastomeric member comprises a 3 to 40 cm wide loop-shaped rubber band.

8. The apparatus as claimed in claim 7 wherein said loop-shaped band has an untensioned length selected at between about 10 and 30 cm.

9. The apparatus as claimed in claim 8 further including at least one retention strap for maintaining at least a portion of said user's leg in juxtaposed contact with said support member.

10. The apparatus as claimed in claim 9 wherein said support member includes a generally horizontally extending support surface configured to support a lower portion of said user's leg in a generally horizontal orientation, with said user's foot suspended a distance from a remainder of said frame.

11. A physiotherapy apparatus for providing a resilient elongation or flexion force to a user's foot, the apparatus comprising,
an elongated resiliently deformable elastomeric member having a first portion and a second portion spaced from said first portion, said second portion being selectively engageable by said user's foot,
a frame comprising a base extending along an axis from a rearward end to a forward end,
a support member mounted to said base for supporting the user's leg thereon in a generally forwardly extending outstretched orientation substantially aligned with said axis,
a distalmost coupling member spaced forwardly from said support surface, said distalmost coupling member configured to selectively engage said second portion to secure said elastomeric member relative to said frame, the relative spacing of distalmost coupling member from said support member and the length of the elastomeric member selected whereby when said user's leg is supported on said support member and first end portion is engaged by said user's foot and said second portion is coupled to the distalmost coupling member, said elastomeric member provides a therapeutic axial tensioning force on said user's foot.

12. The apparatus as claimed in claim 11 further including a pair of lateral coupling members, each of said lateral coupling members being positioned laterally on opposing side of said axis and being selectively couple said second portion of said elastomeric member relative to said frame at positions engageable opposing lateral sides of said user's foot when said user's leg is positioned on said support surface,
wherein when said second portion is coupled to a selected one of said pair of lateral coupling members and said first portion is engaged by said user's foot, said elastomeric member provides a lateral tensioning force on said user's foot in a direction generally transverse to the axis.

13. The apparatus as claimed in claim 12 further including a tensioning coupling member associated respectively with each said lateral coupling members, said tensioning coupling members configured to engage a portion of said elastomeric member remote from each of said first and second portions when said first portion of the elastomeric member is engaged by said user's foot and said second portion is engaged by the associated lateral coupling member, the tensioning coupling members and their associated lateral coupling member being spaced in an axial direction relative to each other, whereby engagement of the tensioning member with the portion of the elastomeric member remote from the first and second portions provides additional distortion and tensioning to said elastomeric member.

14. The apparatus as claimed in claim 13 wherein the frame is configured to support the apparatus with the user seated on the floor.

15. The apparatus as claimed in claim 12 wherein each of said distalmost and lateral coupling members comprise a generally cylindrical peg detachably coupled to said frame.

16. The apparatus as claimed in claim 11 wherein the distalmost coupling member comprises a generally vertically oriented peg aligned with said axis.

17. The apparatus as claimed in claim 11 wherein said elastomeric member is formed as a 3 to 40 cm wide loop-shaped band having an untensioned length selected at between about 20 and 60 cm.

18. The apparatus as claimed in claim 12 further including at least one retention strap for maintaining a calf of said user's leg in juxtaposed contact with said support member.

19. The apparatus as claimed in claim 19 further including at least one retention strap for maintaining a lower portion of said user's leg in juxtaposed contact with said support member.

20. The apparatus as claimed in claim 12 further including a pair of rear coupling members, each of said rear coupling members being positioned on laterally opposing sides of said axis adjacent the rearward end and being selectively engageable to couple a respective portion of said elastomeric member relative to said frame.

21. A portable physiotherapy apparatus for providing resistive exercising movement to a user's limbs, said apparatus comprising,
a frame extending along a generally central axis from a rearward most end to a forward end and having an overall length selected for placement on a top surface of a conventional physiotherapy table,
a support member coupled to said frame for supporting a portion of the user's limb thereon in an exercising position extending generally in a forward outstretched orientation substantially aligned with the axis,
a resiliently deformable elastomeric member,
a distalmost coupling member engageable by a distal portion of said elastomeric member and spaced towards said forward end,
a pair of lateral coupling members each of said lateral coupling members being on laterally positioned opposing sides of said axis
the elastomeric member having a length selected such that when said user's limb is in the exercising position and said elastomeric member is engaged by both said user's limb at least one of said distalmost and lateral coupling members, said elastomeric member exerts a desired tensioning force on said user's limb.
